(19) United States
(12) Patent Application Publication
(10) Pub. No.: US 2013/0184367 A1
(43) Pub. Date: Jul. 18, 2013

(54) FOAMED LIGHTFAST POLYURETHANE MOULDINGS

(71) Applicants: Birgit Meyer Zu Berstenhorst, Leverkusen (DE); Reinhard Halpaap, Odenthal (DE); Norbert Eisen, Koln (DE); Uwe Pfeuffer, Leverkusen (DE)

(72) Inventors: Birgit Meyer Zu Berstenhorst, Leverkusen (DE); Reinhard Halpaap, Odenthal (DE); Norbert Eisen, Koln (DE); Uwe Pfeuffer, Leverkusen (DE)

(73) Assignee: Bayer Intellectual Property GmbH, Monheim (DE)

(21) Appl. No.: 13/820,629

(22) PCT Filed: Sep. 2, 2011
(86) PCT No.: PCT/EP11/65218

§ 371 Date: Mar. 28, 2013

(30) Foreign Application Priority Data
Sep. 7, 2010 (DE) 10 2010 040 305.9

(51) Int. Cl. C08G 18/75

(52) U.S. Cl. CPC C08G 18/751
USPC 521/159

(57) ABSTRACT

The invention relates to foamed lightfast polyurethane mouldings and to the use thereof.

The invention concerns foamed lightfast polyurethane integral moldings and their use.

Polyurethanes (PUs) based on isocyanates having NCO groups attached to an aromatic moiety are known to discolor on exposure to light. This issue affects interior components exposed to light as well as outdoor applications. The production of light-resistant moldings therefore requires a surface having light-resistant properties.

Polyurethanes (PUs) with high resistance to light are typically produced using aliphatically attached isocyanates. EP 0379246 B1 describes using such isocyanates for producing light-resistant PUs. Light-resistant outer skins for application to instrument panels, for example, are produced there. Fabrication of compact and foamed aliphatic skins is possible. The use of water as blowing agent leads to relatively high hardness in the foams which is unwanted at times and which in the region of low densities even exhibit higher hardnesses than the compact skins. Moreover, getting the catalysis right for the blowing and crosslinking reactions is usually tricky when aliphatic isocyanates are used. It is often necessary to use specific metallic catalysts here. Water is accordingly ruled out as blowing agent.

In addition, surfaces in interiors should also perform a certain protective function by having a soft depth-sensing hardness under load. However, despite every softness in depth-sensing hardness, the surfaces must not be easily damaged. This is achieved by a consolidated surface. What is needed is accordingly an integral foam, which has a lower density in the core than at the edge.

The depth-sensing hardness of a material is determined by penetration measurement. A penetrator (for example the H-4236 Cone Penetrometer from Humboldt) with a rounded-off penetration tip. 3 mm in diameter is used to determine the penetration depth at room temperature at 1400 g load at the earliest 24 hours after demolding. Small values (<0.5 mm) denote hard systems, while larger values denote soft, indentable systems. Thus, polyurethane components of flexible depth-sensing hardness have penetration measurements above 0.5 mm.

For a foamed polyurethane to truly qualify for the purposes of the present invention, the free rise density must not be more than 450 kg/m³, and preferably not more than 350 kg/m³.

EP-A 0 652 250 and WO 2009 097990 describe processes for producing cellular polyurethanes from isocyanates of the diphenylmethane series and carbamate blowing agents. The depth-sensing hardness of PU systems blown with carbamate systems or carbon dioxide is dependent on the surface hardness. Therefore, soft systems also have a soft, easily injured skin, while systems having a higher surface density tend to be hard in terms of depth-sensing hardness.

Really good integral foams, i.e., with a large density difference between the core and the skin, are obtainable by using physical blowing agents. To use physical blowing agents is to take advantage of the fact that the polyurethane reaction releases energy in the form of heat which causes the blowing agent(s) to turn gaseous and thus form a foam. At the edge of the component, however, the heat can be removed via the mold, so what is formed there is not a foam but a surface skin having a higher density than in the core. Good skinning thus requires especially a very large temperature difference between the core and the mold wall. The mold temperatures used are therefore usually low.

Aliphatic isocyanates are known to be distinctly less reactive than aromatic isocyanates, and therefore distinctly more energy has to be supplied to the reaction. Mold temperatures of 70-90° C. are thus frequently required to start the reaction at all and effect a full cure. Therefore, the formation of an integral foam should be distinctly more difficult than with aromatic systems. It is accordingly unsurprising that most patents regarding integral foams where aliphatic as well as aromatic polyisocyanates are recited as useful isocyanate components are exemplified using aromatic systems only, see for example DE19836662, EP1219674, EP1282658, US2003225177. It thus remains an open question whether such good results can also be obtained with aliphatic isocyanates.

There is further an ever increasing emphasis on safety. One safety objective is to minimize the use of hazardous materials for economic as well as health considerations, since additional venting, housing, etc. is required to ensure safety. Aliphatic polyisocyanates, as will be known, are only regarded as toxic/harmful when they contain a certain amount of free monomer (toxic, symbol T, at monomer contents ≧2 wt %, harmful, symbol Xn, at monomer contents >0.5 wt % and <2 wt %). Therefore, low-monomer systems should be used for safety reasons. But low-monomer systems have the disadvantage that they have a distinctly lower NCO content than the monomers, for example in the form of uretdiones, isocyanurates, allophanates, biurets, iminooxadiazinedione and/or oxadiazinetrione structure or in the form of reaction products containing urethane and isocyanate groups and known as isocyanate prepolymers. Therefore, distinctly more isocyanate component has to be used in the reaction to form polyurethanes. This has the effect of diluting the polyurethane for the same molding density, i.e., fewer new polyurethane reactions take place than when monomers are used. Since the heat required to develop an integral structure is supplied by the heat of reaction, low-monomer systems ought to have a distinctly worse ability to form a consolidated skin.

The problem addressed by the present invention was therefore that of providing lightfast polyurethanes over a wide apparent-density range that have an elastomeric depth-sensing hardness, for example for the application sector of dashboards, door trims, armrests and consoles, as well as a process for production thereof.

Surprisingly, this problem was solved by polyurethanes obtainable from low-monomer (<0.5 wt % monomer content) modified aliphatic isocyanates and isocyanate-reactive short- and long-chain compounds by using certain physical blowing agents.

The present invention accordingly provides foamed lightfast polyurethane integral moldings having a free rise density of not more than 450 kg/m³ and a density difference of not less than 90 kg/m³ between the core and the skin of the molding, obtainable from
A) organic modified (cyclo)aliphatic polyisocyanate compounds having at least two isocyanate groups not bonded directly to an aromatic group, obtainable from monomeric (cyclo)aliphatic polyisocyanates,
B) polyols having an average molecular weight of 1000-15 000 g/mol and a functionality of 2 to 8, preferably of 2 to 6,
C) polyols or polyamines having a molecular weight of 62-500 g/mol and a functionality of 2 to 8, preferably of 2 to 4, as crosslinkers chain extenders,
D) blowing agents,
E) optionally further, auxiliary or adjunct materials,
   characterized in that said component A) has a monomer content below 0.5 wt % in respect of (cyclo)aliphatic polyisocyanates and blowing agent D) comprises physical blowing agents from the group consisting of (cyclo)aliphatic hydrocarbons having up to 5 carbon atoms, partially halogenated hydrocarbons preferably having 4 to 5 carbon atoms, more preferably having 5 carbon atoms, or partially halogenated olefins each having up to 5 carbon atoms or ethers, ketones or acetates each having up to 5 carbon atoms or nitrogenous hydrocarbons having up to 5 carbon atoms being used in an amount so as to produce a free rise foam having a free rise density of not more than 450 kg/m³ and so as to produce a density difference of not less than 90 kg/m³ between the skin and the core of the molding.

The skin is defined for density-measuring purposes as the outer layer of the molding with a thickness of 1.5 mm.

The modified polyisocyanate compounds A) are produced using (cyclo)aliphatic polyisocyanates as starting compounds. Suitable (cyclo)aliphatic polyisocyanates are preferably any diisocyanates of the molecular weight range 140 to 400 which are obtainable by phosgenation or in a phosgene-free manner, for example by thermal scissioning of urethane, and which have aliphatically or cycloaliphatically bonded isocyanate groups. Useful (cyclo)aliphatic compounds include for example 1,4-diisocyanatobutane, 1,5-diisocyanatopentane, 1,6-diisocyanatohexane (HDI), 2-methyl-1,5-diisocyanatopentane, 1,5-diisocyanato-2,2-dimethylpentane, 2,2,4-trimethyl-1,6-diisocyanatohexane, 2,4,4-trimethyl-1,6-diisocyanatohexane, 1,10-diisocyanatodecane, 1,3- and 1,4-diisocyanatocyclohexane, 1,3-and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane (H₁₂-MDI, possibly in admixture with the 2,4′-isomer), 1-isocyanato-1-methyl-4(3)-isocyanatomethylcyclohexane (IMCI), bis(isocyanatomethyl)norbornane (NBDI) or any mixtures thereof. The modified compounds A) prepared from the monomeric (cyclo)aliphatic polyisocyanates are prepared in a conventional manner. They have monomer concentrations below 0.5 wt % according to the present invention and by way of modification they comprise for example uretdione, isocyanurate, allophanate, biuret, iminooxadiazinedione and/or oxadiazinetrione structures, as described for example in J. Prakt. Chem. 336 (1994) 185-200, in DE-A 1 670 666 and EP-A 0 798 299. Useful modified polyisocyanates A) further include reaction products containing urethane and isocyanate groups and known as isocyanate prepolymers and carbodiimide-modified polyisocyanates. The polyisocyanates A) preferably have an isocyanate content of 10 to 30 wt %. Preferred modified polyisocyanates A) include but are not limited to low-viscosity products based on HDI and having a monomer content <0.5 wt %. Particular preference is given to using HDI-based polyisocyanates containing uretdione groups, and/or HDI-based prepolymers. Very particular preference is given to using HDI-based polyisocyanates containing uretdione groups and/or HDI-based prepolymers, wherein the component A contains altogether less than 5 weight percent of cycloaliphatic polyisocyanates, since cycloaliphatic polyisocyanates are distinctly dearer than HDI-based polyisocyanates.

The component B) has an average hydroxyl functionality of 2 to 8 and preferably consists of at least one polyhydroxy polyether having an average molecular weight of 1000 to 15 000 g/mol, preferably 2000 to 13 000 g/mol and/or at least one polyhydroxy polyester having an average molecular weight of 2000 to 10 000 g/mol, preferably 2000 to 8000 g/mol and/or at least one oligocarbonate polyol having an average molecular weight of 1000-5000 g/mol.

Suitable polyhydroxy polyethers are the products known per se from polyurethane chemistry of alkoxylating preferably di- or trifunctional starter molecules, or mixtures of such starter molecules. Suitable starter molecules are for example water, ethylene glycol, diethylene glycol, propylene glycol, trimethylolpropane, glycerol and sorbitol. Alkylene oxides used for alkoxylating are especially propylene oxide and ethylene oxide, and these alkylene oxides can be used in any order and/or as a mixture. Aliphatic oligocarbonate polyols having an average molecular weight of 1000 to 5000 g/mol, preferably 1000 to 2000 g/mol can further be used as component B). Suitable aliphatic oligocarbonate polyols are the products known per se of reacting monomeric dialkyl carbonates such as, for example, dimethyl carbonate, diethyl carbonate, etc., with polyols or mixtures of polyols having an OH functionality ≧2.0, for example 1,4-butanediol, 1,3-butanediol, 1,5-pentanediol, 1,6-hexanediol, 3-methyl-1,5-pentanediol, 1,12-dodecanediol, cyclohexanedimethanol, trimethylolpropane and/or mixtures of said polyols with lactones, as is described for example in EP-A 1 404 740 and EP-A 1 518 879 A2.

Suitable polyester polyols are the hydroxyl-containing products known per se of esterifying preferably dihydric alcohols, for example ethylene glycol, propylene glycol, neopentyl glycol, 1,4-butanediol and 1,6-hexanediol, with deficient amounts of preferably difunctional carboxylic acids, for example succinic acid, adipic acid, phthalic acid, tetrahydrophthalic acid, hexahydrophthalic acid or mixtures thereof.

Component C) is preferably a difunctional chain-extending agent having a molecular weight of 62 to 500 g/mol, preferably 62 to 400 g/mol. Preferred chain-extending agents C) include dihydric alcohols, for example ethylene glycol, diethylene glycol, 1,4-butanediol, 1,6-hexanediol or mixtures thereof. Likewise suitable for use as component C) or part of component C) are diols having ether groups and molecular weights of below 400 g/mol, of the type obtainable by propoxylation and/or ethoxylation of difunctional starter molecules of the type already mentioned above by way of example. Useful chain-extending agents C) likewise include diamines having arylalkyl-disposed amino groups, for example 1,3-xylyenediamine. It is further also possible to use polycarbonate diols provided their molecular weight is below 500 g/mol. Any desired mixtures of the illustratively recited chain-extending agents can likewise be used. Chain-extending agents C) are used in amounts of 2 to 15, preferably 4 to 12 wt %, based on the weight of total components B), C), D) and E).

Blowing agents D) are essential to the present invention and comprise compounds of the classes already mentioned above. Examples of cyclic hydrocarbons are cyclopropane and cyclopentane. Noncyclic hydrocarbons include butane, n-pentane and isopentane. Halogenated hydrocarbons are hydrogen-containing chlorofluorocarbons or fluorocarbons or perfluoro compounds e.g. perfluoroalkanes. Useful hydrochlorofluorocarbons include chlorodifluoromethane (R22), 1,1-dichloro-1-fluoroethane (R141b), 1-chloro-1,1-difluoroethane (R142b) or 1,3 -dichloro-1,1,2,3,3,hexafluoropropane (R216a). Examples of hydrofluorocarbons are pentafluoroethane (R125), 1,1,1-trifluoroethane (R143a), 1,1,1,2-tetrafluoroethane (R134a), 1,1,2-trifluoroethane (R143), 1,1-difluoroethane (R152a), 1,1,1,3,3-pentafluoropropane (R245fa), octafluoropropane (R218) or 1,1,1,3,3-pentafluorobutane (R365 mfc). Halogenated ethers are hydrogen-containing fluoro- or chlorofluoroethers, for example difluoromethoxy-2,2,2-trifluoroethane (E245).

Examples of useful ethers are dimethyl ether or diethyl ether. Nitromethane is a preferred nitrogenous hydrocarbon. Useful partially halogenated olefins include for example trans-1,3,3,3-tetrafluoroprop-1-ene (HFO-1234ze), 2,3,3 ,3-tetrafluoroprop-1-ene (HFO-1234yf), FEA 1100 (1,1,1,4,4,4-hexafluoro-2-butene) and FEA 1200. With the focus on safety, the use of nonflammable blowing agents is preferable.

Polyurethanes (PUs) are produced using the physical blowing agent D) in an amount of 0.1 to 10 wt %, preferably 1 to 8 wt % and more preferably 2 to 7 wt % based on the weight of total components B), C), D) and E).

The optional auxiliary and adjunct agents E) are compounds of the type known per se. They are the compounds customary and known in the production of polyurethane foams, for example catalysts, stabilizers, pigments, fillers or else water, which is optionally used in an amount of up to 0.3 wt %, based on the weight of component B). Preferably, however, the PUs are produced without added water.

The familiar catalysts commonly used for polyurethane can be used, for example those recited in WO 2008/034884 or EP 0929586. They include not only salts and chelates of tin, zinc, bismuth, iron, mercury but also tertiary amine compounds. Organotin compounds such as, for example, dimethyltin(IV) didodecylmercaptide, dimethyltin(IV) bis(2-ethylhexyl thioglycolate), dimethyltin(IV) dimethylene isooctyl ester mercaptide, dimethyltin(IV) didecylmercaptide, dimethyltin(IV) butenyl dicarboxylate, dimethyltin(IV) dilaurate and dimethyltin(IV) di(neodecyl carboxylate) are used with preference. Nonfungative catalysts should preferably be used.

Stabilizers are not only UV absorbers, antioxidants, radical scavengers but also foam stabilizers. UV absorbers can be not only inorganic compounds such as, for example, titanium dioxide, zinc oxide or cerium dioxide, but also organic compounds, such as 2-hydroxybenzophenones, 2-(2-hydroxyphenyl)benzotriazoles, 2-(2-hydroxyphenyl)-1,3,5-triazines, 2-cyanacrylates and oxalanilides. Radical scavengers are known to include HALS (Hindered Amine Light Stabilizer) systems, while sterically hindered phenols and/or secondary aromatic amines can be used as antioxidants. Foam stabilizers usually consist of polyether siloxanes or block copolymers of polyoxyalkylenes.

Pigments and fillers are for example, calcium carbonate, graphite, carbon black, titanium dioxide, titanium dioxide, iron oxide, wollastonite, glass fibers, carbon fibers or else organic dyes/fillers.

Further examples of component E) “auxiliary and adjunct materials” are given in “Kunststoffhandbuch 7—Polyurethanes”, Becker/Braun, Carl Hanser Verlag, Munich/Vienna, 1993, 104ff.

The starting components are otherwise used in such amounts that an isocyanate index in the range from 80 to 120, preferably 95 to 105 is obtained. The isocyanate index is the quotient formed from the number of NCO groups, divided by the number of NCO-reactive groups and multiplied by 100.

To produce the PU moldings, the general procedure is to combine the components B) to E) into a “polyol component” which is then mixed and reacted with the polyisocyanate component A) in closed molds. Customary measuring and metering devices are used for this.

The temperature of the reaction components (polyisocyanate component A) on the one hand and “polyol component” consisting of the components B), C), D) and E) on the other) is generally within the temperature range from 20 to 60° C. The temperature of the molding equipment is generally in the range from 20 to 100° C., preferably at 50 to 90° C.

The amount of foamable material introduced into the mold is determined so as to obtain apparent densities in the range from 200 to 700 kg/m³ for the moldings.

The moldings are used, for example, as steering wheels or door side trim and also instrument panel coverings or generally as protective cushioning in the automotive interior.

The aliphatic foams are useful as lining for dashboards, consoles, linings of doors or shelves in the field of vehicles.

The examples which follow provide a more particular description of the invention.

### EXAMPLES

The percentages in Tables 1-3 are by weight.

### Polyisocyanate A1):

HDI containing isocyanurate and uretdione groups was prepared by tributylphosphine-catalyzed oligomerization of HDI in line with Example 1a) of EP-A 0 377 177, except that no 2,2,4-trimethyl-1,3-pentanediol was used. The reaction was discontinued at an NCO content of 42% for the crude solution and unconverted HDI was removed by thin-film distillation at a temperature of 130° C. and a pressure of 0.2 mbar.

NCO content: 22.7%

NCO functionality: 2.2

Monomeric HDI: 0.3%

Viscosity (23° C.): 90 mPas

### Polyisocyanate A2):

7 mol of 1,6-diisocyanatohexane (HDI) and 1 mol of a polypropylene oxide diol having a weight-average molecular weight of 400 (OH number=280) were reacted at 80° C. to a constant NCO content. This was followed by the excess of monomeric HDI being removed by thin-film distillation at a temperature of 130° C. and a pressure of about 0.5 mbar.

NCO content: 12.6%

Monomeric HDI: 0.2%

Viscosity (23° C.): 4250 mPas

### Polyisocyanate I:

Mixture of 1 part by weight of HDI and 1 part by weight of polyisocyanate A1).

### Polyisocyanate II:

Mixture of 1 part by weight of polyisocyanate A2) and 1 part by weight of polyisocyanate A1).

### Polyisocyanate III:

Polyisocyanate A1).

### Polyol:

Polyether polyol having an OH number of 28; prepared by alkoxylation of sorbitol with propylene oxide/ethylene oxide (PO/EO) in a weight ratio of 82:18 and predominantly primary OH end groups,

Blowing agents: The blowing agents are added according to the polyisocyanate such that the blowing agent content is in each case about 3.6 wt % based on all materials used.

Blowing agent I: HFC 245 fa [1,1,1,3,3-pentafluoropropane from Honeywell]

Blowing agent II: Isohexane

Blowing agent III: Pentane

Tables 1 to 3 hereinbelow describe the components and employed amounts for producing the polyurethanes.

TABLE 1
Compositions

| Example | 1 | 2* | 3* | Component |
|---|---|---|---|---|
| Polyol | 81.0 | 81.0 | 81.0 | B |
| Isophoronediamine | 1.0 | 1.0 | 1.0 | C |
| (chain extender) | | | | |
| Coscat 83 | 0.5 | 0.5 | 0.5 | E |
| (catalyst); | | | | |
| from Erbslöh KG | | | | |
| 1,4-butanediol | 9.5 | 9.5 | 9.5 | C |
| diethanolamine | 2.0 | 2.0 | 2.0 | C |
| blowing agent I | 5.0 | 6.3 | 5.8 | D |
| isocyanate I | 37.5 | — | — | A |
| isocyanate II | — | 76.1 | — | A |
| isocyanate III | — | — | 59.6 | A |

*in accordance with the present invention

TABLE 2
Compositions

| Example | 4 | 5 | 6 | Component |
|---|---|---|---|---|
| polyol | 81.0 | 81.0 | 81.0 | B |
| isophoronediamine | 1.0 | 1.0 | 1.0 | C |
| (chain extender) | | | | |
| Coscat 83 | 0.5 | 0.5 | 0.5 | E |
| (catalyst); | | | | |
| from Erbslöh KG | | | | |
| 1,4-butanediol | 9.5 | 9.5 | 9.5 | C |
| diethanolamine | 2.0 | 2.0 | 2.0 | C |
| blowing agent II | 5.0 | 6.3 | 5.8 | D |
| isocyanate I | 37.5 | — | — | A |
| isocyanate II | — | 76.1 | — | A |
| isocyanate III | — | — | 59.6 | A |

TABLE 3
Compositions

| Example | 7 | 8* | 9* | component |
|---|---|---|---|---|
| polyol | 81.0 | 81.0 | 81.0 | B |
| isophoronediamine | 1.0 | 1.0 | 1.0 | C |
| (chain extender) | | | | |
| Coscat 83 | 0.5 | 0.5 | 0.5 | E |
| (catalyst); | | | | |
| from Erbslöh KG | | | | |
| 1,4-butanediol | 9.5 | 9.5 | 9.5 | C |
| diethanolamine | 2.0 | 2.0 | 2.0 | C |
| blowing agent III | 5.0 | 6.3 | 5.8 | D |
| isocyanate I | 37.5 | — | — | A |
| isocyanate II | — | 76.1 | — | A |
| isocyanate III | — | — | 59.6 | A |

*in accordance with the present invention

TABLE 4
Properties

| Example | 1 | 2* | 3* |
|---|---|---|---|
| Free rise density [kg/m³] measured to | 176 | 304 | 311 |
| DIN EN ISO 845 | | | |
| Hazchem designation of | T, N/- | Xi, N/- | Xi/- |
| isocyanate/blowing agent | | | |
| Apparent overall density [kg/m³] | 511 | 520 | 564 |
| measured to DIN EN ISO 845 | | | |
| Apparent skin density [kg/m³] measured | 765 | 600 | 675 |
| to DIN EN ISO 845 | | | |
| Apparent core density [kg/m³] measured | 430 | 500 | 532 |
| to DIN EN ISO 845 | | | |
| Delta apparent density skin-core | 335 | 100 | 143 |
| [kg/m³] | | | |
| Penetration 1400 g, 3 mm diameter | 1.9 | 5.1 | 4.0 |
| penetration tip [mm] | | | |

*in accordance with the present invention

TABLE 5
Properties

| Example | 4 | 5 | 6 |
|---|---|---|---|
| Free rise density [kg/m³] measured to | 246 | 470 | 480 |
| DIN EN ISO 845 | | | |
| Hazchem designation of | T, N/F | Xi, N/F | Xi/F |
| isocyanate/blowing agent | | | |
| Apparent overall density [kg/m³] | 566 | — | — |
| measured to DIN EN ISO 845 | | | |
| Apparent skin density [kg/m³] measured | 787 | — | — |
| to DIN EN ISO 845 | | | |
| Apparent core density [kg/m³] measured | 474 | — | — |
| to DIN EN ISO 845 | | | |
| Delta apparent density skin-core | 313 | — | — |
| [kg/m³] | | | |
| Penetration 1400g, 3 mm diameter | 1.0 | — | — |
| penetration tip [mm] | | | |

TABLE 6
Properties

| Example | 7 | 8* | 9* |
|---|---|---|---|
| Free rise density [kg/m³] measured to | 123 | 180 | 196 |
| DIN EN ISO 845 | | | |
| Hazchem designation of | T, N/F | Xi, N/F | Xi/F |
| isocyanate/blowing agent | | | |
| Apparent overall density [kg/m³] | 546 | 577 | 533 |
| measured to DIN EN ISO 845 | | | |
| Apparent skin density [kg/m³] measured | 680 | 674 | 687 |
| to DIN EN ISO 845 | | | |
| Apparent core density [kg/m³] measured | 467 | 525 | 504 |
| to DIN EN ISO 845 | | | |
| Delta apparent density skin-core | 213 | 149 | 183 |
| [kg/m³] | | | |
| Penetration 1400g, 3 mm diameter | 1.6 | 4.3 | 3.5 |
| penetration tip [mm] | | | |

*in accordance with the present invention

Mold temperature was 70° C., mold size was 100×100×20 mm. The temperature of the components used was room temperature (25° C.) for the isocyanate and for the polyol formulation. The amount introduced into the mold was determined such that the stated apparent density resulted.

Tests 1, 4 and 7 are comparative tests, which contain a large amount of monomeric diisocyanates. It is clearly apparent that they can be efficiently foamed with any blowing agent, since the free rise densities are far below the required 450 kg/m³ and exhibit good skinning (difference between apparent skin density versus apparent core density) of distinctly above 90 kg/m³. However, these comparative tests all have the appreciable disadvantage that they are produced using large amounts of low molecular weight monomeric aliphatic diisocyanates which are classed as harmful, sensitizing or even poisonous materials and in some instances have a high vapor pressure. Processing these monomeric diisocyanates requires considerable safety engineering for occupational hygiene reasons. In addition, there is the possibility with using excess polyisocyanate in particular that unconverted monomeric diisocyanate will long remain in the produced foam and gradually be off-gassed out of the foam over time.

By contrast, combinations 2, 3, 8 and 9 according to the present invention and comparative tests 5 and 6, which use low-monomer polyisocyanates, are distinctly simpler to process. The polyisocyanates have a low vapor pressure, there is no monomeric diisocyanate in the ambient air at the processing stage. There is virtually no monomeric diisocyanate to off-gas out of the final part. However, it is apparent that combinations 5 and 6 each have a very high free rise density, i.e., they only foam up minimally. Therefore, isohexane is not very useful as blowing agent for polyurethane foams based on low-monomer aliphatic polyisocyanates.

It is otherwise apparent that skinning is somewhat compromised with low-monomer polyisocyanates versus the comparative tests, but that systems 2, 3, 8 and 9 according to the present invention nonetheless exhibit sufficient consolidation of the surface. Furthermore, the examples in accordance with the present invention are distinctly softer (see penetration values).

Examples 2 and 3 additionally utilize an incombustible physical blowing agent which affords further advantages concerning the safety aspect on the polyol side.

The polyurethane systems used according to the present invention, which have good occupational-hygiene handling properties, provide foams which are flexible but also exhibit adequate skinning. However, it must be borne in mind that forming these flexible foams with an appropriate skin is only successful with the blowing agents used according to the present invention. When isohexane is used as blowing agent, this is unsuccessful despite the use of the polyisocyanates used according to the present invention (tests 5 and 6).

1. (canceled)

2. A foamed lightfast polyurethane integral molding having a free rise density of not more than 450 kg/m³ and a density difference of not less than 90 kg/m³ between the core and the skin of the molding, obtained from
A) an organic modified (cyclo)aliphatic polyisocyanate compound having at least two isocyanate groups not bonded directly to an aromatic group, obtained from a monomeric (cyclo)aliphatic polyisocyanate,
B) a polyol having an average molecular weight of 1000-15 000 g/mol and a functionality of 2 to 8,
C) a polyol or polyamine having a molecular weight of 62-500 g/mol and a functionality of 2 to 8, as crosslinker/chain extender,
D) a blowing agent,
E) optionally further, auxiliary or adjunct materials,
wherein component A) has a monomer content below 0.5 wt % in respect of (cyclo)aliphatic polyisocyanates and blowing agent D) comprises physical blowing agents selected from the group consisting of (cyclo)aliphatic hydrocarbons having up to 5 carbon atoms, partially halogenated hydrocarbons having up to 5 carbon atoms or partially halogenated olefins having up to 5 carbon atoms or ethers, ketones or acetates each having up to 5 carbon atoms and nitrogenous hydrocarbons having up to 5 carbon atoms, used in an amount so as to produce a free rise foam having a free rise density of not more than 450 kg/m³ and so as to produce a density difference of not less than 90 kg/m³ between the skin and the core of the molding.

3. The foamed lightfast polyurethane integral molding of claim 2, wherein component B) has functionality of 2 to 6.

4. The foamed lightfast polyurethane integral molding of claim 2, wherein component C) has functionality of 2 to 4.
